(19) United States
(12) Patent Application Publication
(10) Pub. No.: US 2018/0123813 A1
(43) Pub. Date: May 3, 2018

(54) Augmented Reality Conferencing System and Method

(71) Applicant: BRAGI GmbH, Munchen (DE)

(72) Inventors: Veniamin Milevski, München (DE); Peter Vincent Boesen, München (DE)

(73) Assignee: BRAGI GmbH, München (DE)

(21) Appl. No.: 15/790,514

(22) Filed: Oct. 23, 2017

Related U.S. Application Data
(60) Provisional application No. 62/414,943, filed on Oct. 31, 2016.

(51) Int. Cl. H04L 12/18; G02B 27/01; H04R 1/10

(52) U.S. Cl. CPC H04L 12/1813; G02B 27/017; G02B 2027/0138; H04R 1/1091; G02B 2027/0178; H04R 1/1016

(57) ABSTRACT

A system, method, and wireless earpieces for augmented reality communications. A location of two or more users is determined. A first user is in a first location and second user is in a second location remote from the first location. Voice content is captured from the first user and the second user through at least wireless earpieces worn by the first user and the second user. Communications including the augmented reality content are sent between at least the first user and the second user.

### PRIORITY STATEMENT

This application claims priority to U.S. Provisional Patent Application 62/414,943, filed on Oct. 31, 2016, and entitled Augmented Reality Conferencing System and Method, hereby incorporated by reference in its entirety.

### BACKGROUND

### I. Field of the Disclosure

The illustrative embodiments relate to conferencing communications within augmented reality, virtual reality, and telepresence systems. More specifically, but not exclusively, the illustrative embodiments relate to interactions between one or more users, wireless earpieces, and enhanced communications systems.

### II. Description of the Art

The growth of conferencing systems that utilize virtual reality and augmented reality technologies is growing nearly exponentially. This growth is fostered by the decreasing size of microprocessors, circuity boards, projectors, displays, chips, and other components. Various virtual reality and augmented reality systems, such as headsets, are decreasing in size and increasing in functionality, but are still bulky and heavy. The additional mass of headphone units worn by a user may further unbalance motion of the user's head when utilizing a virtual reality system. Tracking the locations, positions, motion, acceleration, and orientation, such as a number of users positioned within a conferencing room relative to each other, may be difficult. In addition, some existing systems and devices, such as external microphones, have significant latency when sending and receiving audio communications.

### SUMMARY OF THE DISCLOSURE

One embodiment provides a system, method, and wireless earpieces for augmented reality communications. A location of two or more users is determined. A first user is in a first location and second user is in a second location remote from the first location. Voice content is captured from the first user and the second user through at least wireless earpieces worn by the first user and the second user. Communications including the augmented reality content are sent between at least the first user and the second user. Another embodiment provides wireless earpieces. The wireless earpieces include a processor for executing a set of instructions and a memory for storing the set of instructions. The set of instructions are executed to perform the method described above.

Yet another embodiment provides wireless earpieces. The wireless earpieces include a processor for executing a set of instructions. The wireless earpieces further include a memory for storing the set of instructions. The set of instructions are executed to determine a location of a first user in a first location, capture voice content from the first user through one or more speakers of the wireless earpieces, wherein the voice content is integrated with at least video content to generate augmented reality content of the first user, receive augmented reality content from a second user utilizing second wireless earpieces, wherein the wireless earpieces play voice content from the second user and augmented reality glasses in communication with the wireless earpieces display video content from the second user, and communicate the augmented reality content of the first user to at least the second user, wherein the wireless earpieces communicate with augmented reality glasses worn by the first user.

Yet another embodiment provides an augmented reality system. The augmented reality system includes augmented reality glasses for displaying augmented reality content to a first user including one or more additional users as if located proximate the user. The augmented reality system further includes wireless earpieces including sensors that detect a position and an orientation of a head of the first user, wherein the wireless earpieces play audio content from the augmented reality content to the first user as if the one or more additional users are proximate the user, and wherein the wireless earpieces receive audio content from the first user for communication to the one or more additional users as part of the augmented reality content.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a conferencing system 100 in accordance with an illustrative embodiment;

FIG. 2 is a pictorial representation of augmented reality conferencing system 200 in accordance with an illustrative embodiment;

FIG. 3 is a block diagram of wireless earpieces and virtual reality headset in accordance with an illustrative embodiment; and

FIG. 4 is a flowchart of a process for communicating utilizing an augmented reality system in accordance with an illustrative embodiment; and

FIG. 5 depicts a computing system in accordance with an illustrative embodiment.

### DETAILED DESCRIPTION OF THE DISCLOSURE

The illustrative embodiments provide a system and method for conferencing communications utilizing wireless earpieces. The wireless earpieces may communicate with a conferencing system, augmented reality system, or virtual reality system as a separate or joint system. The illustrative embodiments may be utilized to allow one or more remote users to participate in a conference utilizing augmented or virtual reality. The illustrative embodiments may utilize augmented or virtual reality to present the remote user(s) as if present at a location of the conference.

In one embodiment, the location and orientation of distinct users may be determined utilizing information from the wireless earpieces that may be paired with or physically connected to glasses or headsets. For example, any number of wireless earpieces utilized within the system may determine the spatial location, distances, orientation, volume, voice characteristics, and other applicable information of the users, furniture, and equipment within a conferencing area. The conferencing area may represent any number of rooms, vehicles, open spaces, or other locations where a conference may be implemented or held.

In one embodiment, the various users may be positioned within the conferencing area and displayed to each other for enabling effective, real-time, and lifelike interactions. The three-dimensional determination of direction, location, orientation, and volume of sound and audio within the conferencing area may be measured, analyzed, and utilized to display and communicate applicable images, video, audio, data, and other information to the user. In one embodiment, a camera system proximate a remote user may capture video or images of the user for utilization with the illustrative embodiments. A camera system may also be integrated as part of the conference area for capturing video and images of the user so that all of the users may be shown an image or video of each other.

The wireless earpieces may communicate with the conferencing system, such as a virtual reality or augmented reality headset, glasses, display, holographic display, or projector (hereinafter “glasses”), in real-time (or near real-time). The glasses may communicate with the wireless earpieces wirelessly or utilizing a wired connection. In one embodiment, the glasses may be coupled to the wireless earpieces utilizing magnetic connectors. For example, wires extending from the glasses may magnetically couple and utilize induction communications and power transfer to power the wireless earpieces. In another example, ports and interfaces, such as micro-USB connectors may be utilized to connect the wireless earpieces to the glasses. In another example, a wireless protocol, standard, connection, or link, such as Bluetooth may be utilized.

The illustrative embodiments may be utilized for entertainment, scientific, educational, or commercial applications. Glasses including virtual reality or augmented reality headsets, heads-up displays, helmets, or other vision or display systems, such as those produced by Google, HTC, Samsung, oculus, Sony, Microsoft, and so forth, may present any number of two-dimensional or three-dimensional visualizations to the user. The illustrative embodiments minimize the existing mass problems with bulky over-ear headphones or other audio systems. As a result, the characteristics of angular momentum associated with the user's head are not increased significantly decreasing the effects of torque and neck and head strain that may be associated with such virtual reality systems.

In addition, user participating in a conference may not be required to utilize microphones that sit on a desk or are externally positioned from the user decreasing the effectiveness of the microphone. For example, many remotely positioned microphones do not have any additional sensors and their remote position may increase latency and delay when sensing various audio inputs from the user, environment, or so forth. The illustrative embodiments allow a conference system to incorporate position, orientation, movement, and acceleration (e.g., angular, linear, etc.) as part of the user input, responses, and feedback. As a result, the audio and visual information presented to the user may be adjusted in response to audio input received from the user as well as the corresponding user information including position, orientation, movement, and acceleration.

The wireless earpieces may include any number of sensors that may communicate with the sensors, systems and components of the conferencing system to further enhance the user's experience. In one embodiment, the sensors of the wireless earpieces may include touch sensors, proximity sensors, accelerometers, gyroscopes, magnetometers, optical sensors, pulse oximeters, GPS chips, thermometers, and so forth. The data acquired by the sensors may be utilized to determine the user's condition, characteristics, position, orientation, movement, acceleration, location, or so forth. As a result, the data may be utilized to enhance the users experience within the video conference. In addition, the sensors provide data that enhances sensor measurements of the glasses. The precise determination of the user's location, orientation, movement, and position may also be utilized to provide more accurate three-dimensional spatial video and sound imaging for the user. For example, allowable or communicated content, actions, and processes implemented by the glasses may vary based on the applicable user information In addition, the sensors may be utilized to sense any number of biometric readings or information, such as heart rate, respiratory rate, blood, or skin physiology, or other biometric data. This information may be utilized to determine whether the user is stressed, fatigued, or so forth. In one example, the video conference may be controlled based on user information. Besides being connected to or integrated with the glasses, the wireless earpieces may be utilized to make and receive communications (e.g., telephone calls, transcribed text messages, audio/tactile alerts, etc.), play music, filter or block sound, amplify sounds, or so forth.

The wireless earpieces may be utilized for daily activities, such as gaming, business communications, exercising, phone calls, travel, and so forth. The wireless earpieces may then also serve a dual-purpose by integrating as an audio portion of a conferencing system. As a result, more expensive audio components are not required thereby reducing the cost and weight of the conferencing system. The sensor and audio inputs sensed by the wireless earpieces are processed with minimal latency due to positions of the microphones within the wireless earpieces at the lateral and medial segments as positioned within the ears of the user. The microphone and other sensor inputs provide enhanced input modality to the conferencing programs and processes implemented by the wireless earpieces.

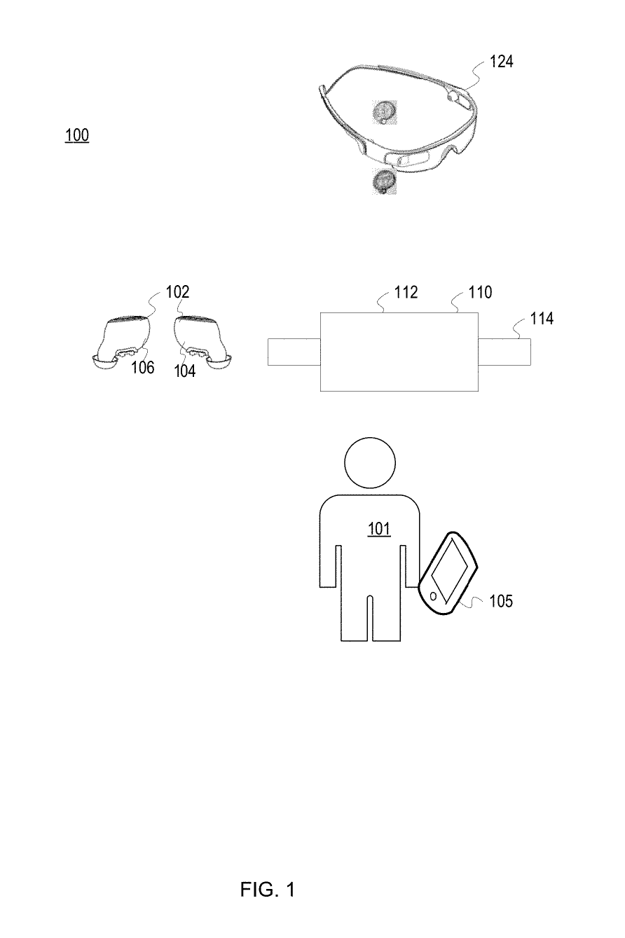

FIG. 1 is a pictorial representation of a conferencing system 100 in accordance with an illustrative embodiment. The conferencing system 100 may include any number of devices, components, systems, and participants. In one embodiment, the conferencing system 100, may include a user 101, wireless earpieces 102 including a right earpiece 104 and a left earpiece 106, wireless headset 110 including a visor 112, a strap 114. The wireless earpieces 102 may be referred to as a pair or set (wireless earpieces 102) or singularly (wireless earpiece 102, right earpiece 104, left earpiece 106). The augmented reality glasses 124 are shown as an alternative to the wireless headset 110. The description, components, and functionality of the wireless headset 110 is similarly applicable to the augmented reality glasses 124.

The description may also refer to components and functionality of each of the wireless earpieces 102 collectively or individually. In one embodiment, the wireless earpieces 102 include a left earpiece and a right earpiece configured to fit into ears of a user 101. The wireless earpieces 102 are shown separately from their positioning within the ears of the user 101 for purposes of simplicity.

The wireless earpieces 102 are configured to play audio associated with conference and visual content presented by the wireless headset 110. The wireless earpieces 102 may be configured to play music or audio, receive and make phone calls or other communications, determine ambient environmental readings (e.g., temperature, altitude, location, speed, heading, etc.), read user biometrics and actions (e.g., heart rate, motion, sleep, blood oxygenation, calories burned, etc.), and communicate content audibly, tactilely, and visually.

The wireless earpieces 102 may include interchangeable parts that may be adapted to fit the needs of the user 101 (e.g., size and shape of the user's ear). For example, sleeves of the wireless earpieces 102 that fit into the ear of the user 101 may be interchangeable to find a suitable shape and configuration. The wireless earpieces 102 may include a number of sensors and input devices including, but not limited to, pulse oximeters, microphones, pulse rate monitors, thermometers, touch sensors, accelerometers, gyroscopes, optical sensors, global positioning sensors, and so forth. Sensors, components, or sub-systems of the wireless headset 100 may also be configured to wirelessly communicate with the wireless earpieces 102.

The wireless headset 110 replicates or displays an environment (e.g., conference room, home office, etc.) simulating physical presence of users in the real world or imagined worlds and lets the users interact in that environment. The conferencing system 100 may be utilized to function in an augmented reality, virtual reality, projection, display, or holographic environment (e.g., including the associated signals, displays, equipment, etc.). The wireless headset 110 or the augmented reality glasses 124 may generate a live direct or indirect view of a physical, real-world environment, such as a conference room, where computer-generated sensory input, such as sound, video, graphics, data, or other information is added or supplemented to enhance the view. Virtual reality may also be referred to as immersive multimedia and may be utilized to create sensory experiences which may include sight, hearing, touch, smell, and taste. The wireless headset 100 may be powered by a power plug, battery, or other connection (e.g., USB connection to a computing or gaming device). The wireless headset 100 may also communicate (send and receive) data utilizing a wired or wireless connection to any number of computing, communications, or entertainment devices.

The visor 112 may be utilized to display visual and graphical information to the user 101. The visor 112 may include one or more displays (e.g., liquid crystal displays, light emitting diode (LED) displays, organic LED, etc.) or projectors (direct, indirect, or refractive) for displaying information to the eyes of the user 101. Although not shown, the wireless headset 100 may also include touch screens, EEG interfaces, tactile interfaces, vibration components, ultrasonic or infrared interfaces, smell interfaces, or tasting interfaces for enhancing the experience of the user 101. The size and shape of the wireless headset 100, visor 112, and the strap 114 may vary by make, model, manufacturer as well as user configuration of the wireless headset 100, such as those produced by Google, HTC, Sony, Oculus, Epson, Samsung, LG, Microsoft, Durovis, Valve, Avegant, and others. In one embodiment, the visor 110 may be transparent allowing the user to interact and function in the real-world while still communicating virtual information. The visor 110 may also transition between transparent and opaque (or a viewing mode) for displaying applicable content. For example, electronic glass utilizing a current and specialized layers of materials (e.g., gasses, coatings, etc.) may be utilized to control the visor 110. The wireless earpieces 102, visor 112, wireless headset 100 may be configured for augmented reality functionality, processes, displays, and so forth as are herein described.

The strap 114 extends between sides of the visor 112 and is configured to secure the wireless headset 100 to the head of the user 101. The strap 114 may be formed of any number of materials, such as cotton, polyester, nylon, rubber, plastic, or so forth. The strap 114 may include buckles, loops, or other adjustment mechanisms for fitting the wireless headset 100 to the head of the user 101. The strap 114 may be flexible to comfortably fit to the head of the user 101. The strap 114 may also incorporate biometric or environmental sensors, such as EEG sensors or transmitters, for interfacing with the user. The strap 114 may also include a battery, solar cells, piezo electric components, wires, busses, or so forth for powering the visor 112 or communicating data or information to other components of the wireless headset 110. The strap 114 may also be replaced by any number of earpieces, frames, support pieces, or so forth.

Some virtual reality headsets are much more helmet-like or include various structural components (e.g., straps, arms, extensions, etc.) for securing the wireless headset 110 to the head of the user during both regular and vigorous usage.

The wireless earpieces 102 communicate with the headset 110 utilizing the connectors (not shown) or the wireless earpieces 102 may communicate utilizing any number of wireless connections, standards, or protocols (e.g., near field communications, Bluetooth, Wi-Fi, ANT+, proprietary, etc.). The wireless headset 100 may locally or remotely implement and utilize any number of operating systems, kernels, instructions, or applications that may make use of the sensor data and other information measured by the wireless earpieces 102. For example, the wireless headset 100 may utilize any number of android, iOS, Windows, open platform, or other systems. Similarly, the wireless headset 100 may include a number of applications that utilize the biometric data from the wireless earpieces 102 to display applicable information and data. For example, the biometric information (including, high, low, average, or other values) may be processed by the wireless earpieces 102 or the wireless headset 100 to display heart rate, blood oxygenation, altitude, speed, distance traveled, calories burned, or other applicable information.

In one embodiment, a wireless device 105 may include any number of sensors (e.g., similar to those described with regard to the wireless earpieces 104) that may be utilized to augment the sensor readings of the wireless earpieces 104. For example, a microphone of the wireless device 106 may determine an amount and type of ambient noise. The noise may be analyzed and utilized to filter the sensor readings made by the wireless earpieces 104 to maximize the accuracy and relevance of the sensor measurements of the wireless earpieces 104. Filtering, tuning, and adaptation for the sensor measurements may be made for signal noise, electronic noise, or acoustic noise, all of which are applicable in the communication system 100.

The cameras of the wireless device 105 may also be utilized to position the user 101 within the environment of the conferencing system 100. For example, the cameras of the wireless device 105 may determine location and orientation of the user 101 as well as the user's environment to provide augmented reality content. In other embodiments, the conferencing system may include a number/array of microphones and cameras for detecting noises, audio, and video associated with the user 101 and the conferencing system 100. In addition, the conferencing system 100 may utilize any number of other devices, components, systems, or equipment.

The wireless headset 100 may also include accelerometers, gyroscopes, magnetometers, radar sensors, and so forth that determine the location, position, and orientation of the user 101 within the conferencing system 100 which may represent a number of indoor or outdoor environments. Sensor measurements made by either the wireless earpieces 104, wireless device 106, or sensor devices of the user 102 may be communicated with one another in the communication system 100. The wireless device 106 is representative of any number of personal computing, communications, exercise, medical, or entertainment devices that may communicate with the wireless earpieces 104.

With respect to the wireless earpieces 104, sensor measurements may refer to measurements made by one or both of the wireless earpieces 104. For example, the wireless earpieces 104 may determine that the sensor signal for the microphone of the right wireless earpiece is very noisy and as a result, may utilize the microphone ratings from the microphone of the left wireless earpiece as the primary reading. The wireless earpieces 104 may also switch back and forth between microphones of the left earpiece 106 and the right earpiece 104 in response to varying noise for both of the wireless earpieces 102. As a result, the clearest sensor signal may be utilized at any given time. In one embodiment, the wireless earpieces 104 may switch sensor measurements in response to the sensor measurements exceeding or dropping below a specified threshold.

The user 102 may also be wearing or carrying any number of sensor-enabled devices, such as heart rate monitors, pacemakers, smart glasses, smart watches or bracelets (e.g., Apple watch, Fitbit, etc.), or other sensory devices that may be worn, attached to, or integrated with the user 102. The data and information from the external sensor devices may be communicated to the wireless earpieces 104. In another embodiment, the data and information from the external sensor devices may be utilized to perform additional processing of the information sent from the wireless earpieces 104 to the wireless device 106.

The sensors of the wireless earpieces 104 may also be positioned at enantiomeric locations. For example, a number of colored light emitting diodes may be positioned to provide variable data and information, such as heart rate, respiratory rate, and so forth. The data gathered by the LED arrays may be sampled and used alone or in aggregate with other sensors. As a result, sensor readings may be enhanced and strengthened with additional data.

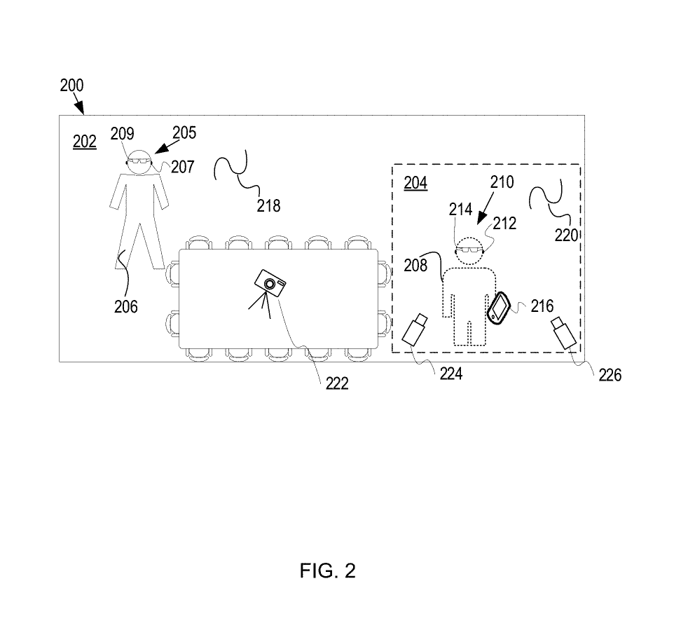

FIG. 2 is a pictorial representation of augmented reality conferencing system 200 in accordance with an illustrative embodiment. The augmented reality conferencing system 200 may include any number of devices, systems, equipment, or components. In one embodiment, the augmented reality conferencing system 200 may include a first environment 202 and a second environment 204. A first user 206 may be present in the first environment 202 and a second user 208 may be present in the second environment 206. The first user 206 may represent one or more users in a location, such as a conference room. The first user 206 made utilizing reality system 205 which may include wireless earpieces 207 and augmented reality glasses 209. The second user 208 may represent a user remotely located in the second environment 204. The second user 208 may be utilizing the augmented reality system 210 which may include wireless earpieces 212, augmented reality glasses 214, and wireless device 216. Sounds 218 represent sounds and audio in the first environment 202 and sounds 220 may represent sounds and audio in the second environment 204. Camera 222 represents one or more cameras within the first environment 202. For example, the camera 222 may be an array of cameras located in a central location or throughout the first environment 202. Cameras 224 and 226 may represent cameras within the second environment 204. The cameras 224 and 226 may capture the position and information associated with the second user 208. The cameras 222, 224, and 226 capture images, video, and/or audio associated with their respective environments. The cameras 222, 224, and 226 may utilize any number of wavelengths or spectra to capture images, movement, and data associated with the first user 206 and the second user 208, respectively. The cameras 222, 224, and 226 may be stationary or configured to rotate, zoom, pan, or otherwise capture any number of users within the first environment 202 and the second environment 204.

The augmented reality glasses 209 and 214 are wearable classes or displays that communicate a live direct or indirect view of a physical, real world environment, such as the first environment 202 and the second environment 204, with augmented (or supplemented) input, such as video, graphics, sound, GPS data, or so forth. In one embodiment, the augmented reality content may be generated by the augmented reality systems 205 and 210 or their respective components (e.g., wireless headsets 207 and 212, augmented reality glasses 209 and 214, augmented reality processing systems, virtual reality processing systems, etc.). As shown, the components of the augmented reality systems 205 and 210 may be physically or wirelessly linked, paired, or associated for any number of communications. In one embodiment, the augmented reality glasses 209 may be paired with the wireless earpieces 207 and the augmented reality glasses 214 may be paired with the wireless earpieces 212.

The illustrative embodiments of the conference system 200 may be utilized to display the second user 208 to the first user 206 through the augmented reality glasses 209 as if the second user 208 was actually present in the first environment 202 where the first user 206 is physically located. Similarly, the embodiments of the conference system 200 may be utilized to display the first user 206 to the second user 208 through the augmented reality glasses 214 as if the first user 206 was actually present in the second environment 204 where the second user 208 is located.

The first environment 202 may further include one or more displays, projection systems, holographic systems, or so forth that may be utilized to display the second user 208 as if she were in the first environment 202. Likewise, the second environment 204 may also include televisions, monitors, projectors, or other display systems for communicating audio and video captured from the first environment 202.

In one embodiment, the second environment 204 may represent a home office, remote conference room, or other location or facility available to the second user 208. The illustrative embodiments may be utilized for convenience regardless of the distance or circumstances that may separate the first user 206 from the second user 208.

In one embodiment, the augmented reality systems 205 and 210 may determine the location, position, orientation, and other spatial information for users, such as the first user 206 and the second user 208. The augmented reality systems 205 and 210 may also determine the speech, verbal, or other audio content received from each of the users 206 and 208. In one embodiment, the wireless earpieces 207 and 212 may perform audio triangulation, ranging, or analysis to determine the applicable information, such as location, position, and orientation of the user within the first environment 202 and the second environment 204 as well as spatial relations to other users, furniture, communications equipment (e.g., cameras, microphones, displays, etc.), and other objects and individuals within the first environment 202 and the second environment 204. In one embodiment, the wireless earpieces 207 and 212 may utilize time delays in receiving either of the sounds 218 and 222 determine the respective locations of individuals and objects within the three-dimensional space of the first environment 202 and the second environment 204.

The augmented reality systems 206 and 210 may generate a virtual environment that is utilized to generate the augmented reality content. In one embodiment, each of the users including at least the first user 206 and the second user 208 may be virtually placed within the created environment. As a result, the first user 206 may be able to look around and see the other users in a designated location. Locations may be assigned based on user preferences or settings. Although not shown, any number of beacons may be utilized within the first environment 202 and the second environment 204 (e.g., positioned on the first user 206 and second user 208, furniture, etc.) to determine the spatial and relative positons of the first user 206 and the second user 208. In addition, laser radar (LIDAR), radar, wireless imaging, or other processes may be utilized to determine the positions of the user.

Similarly, the wireless earpieces 207 and 212 may play audio content as if spoken by a particular user. For example, the stereo or balance effect of the left and right wireless earpieces may be utilized to play content to either the first user 206 or the second user 208 as if the first environment 202 and the second environment 204 were a single cohesive or virtual environment or conference location. The cameras 222, 224, and 226 may similarly capture video or image content that may be similarly displayed to the respective first user 206 or the second user 2 away utilizing the augmented reality glasses 209 and 214. The location, orientation, and other visual information associated with the first environment 202 and the second environment 204 may be merged utilizing augmented reality so that at least the first user 206 and the second user 208 are able to communicate as if in a single location.

The audio, video, data, and other information from the first environment 202 and the second environment 204 may be integrated or coupled to provide an augmented reality experience as part of the conference between at least the first user 206 and the second user 208. The speakers the wireless earpieces 209 and 214 may communicate the audio as if each of the users were present in the first environment 202. For example, the wireless earpieces 209 may play audio to the first user 206 indicating that the second user 208 is to the left of the first user 206 within the first environment 202 (e.g., playing speech signals of the second user 208 primarily through a left wireless earpiece). The wireless earpieces 209 and 214 may utilize stereophonic sound through the two or more speakers of each set of the wireless earpieces 209 and 214 to create the impression of sound heard from various directions as in natural hearing. Thus, even though the conference system 200 represents a virtual or augmented environment, the first user 206 and the second user 208 may experience sounds and visual content as if present in the same location. In another embodiment, the wireless earpieces 209 and 214 may utilize duophonic processing and sound communications to simulate more complex stereo sound environments.

Similarly, the augmented reality glasses 209 and 214 may visually present the users and objects (e.g., first user 206, second user 208, other users, furniture, objects, projected/displayed images, etc.) whether physically present or not. In one embodiment, the augmented reality glasses 209 display the second user 208 as if within the first environment 202 even though the user is in the second environment 204.

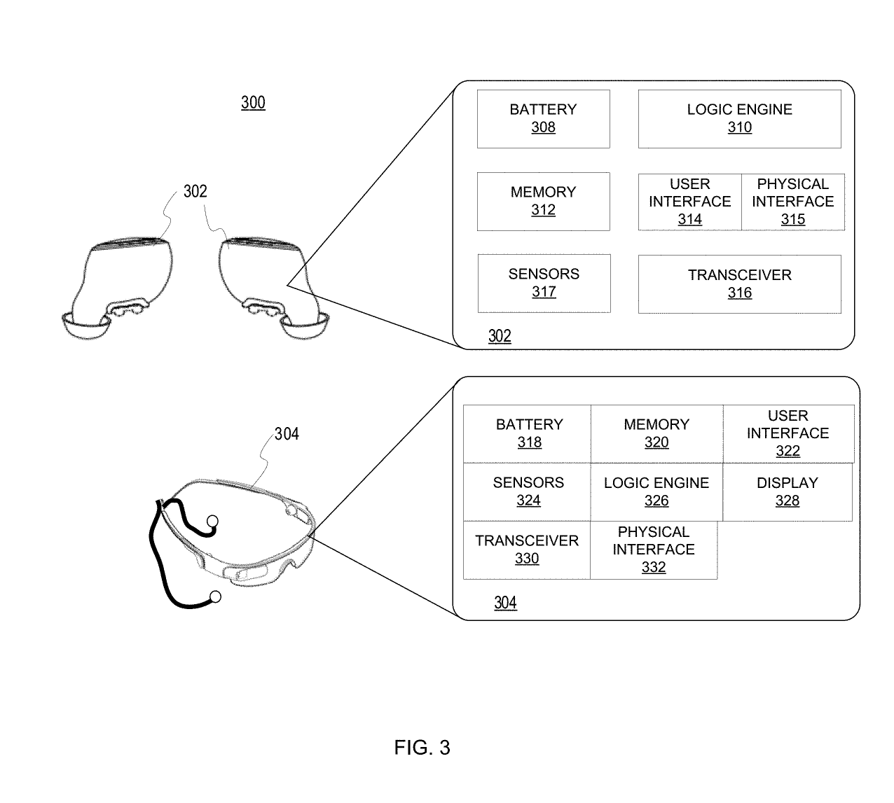

FIG. 3 is a block diagram of an augmented reality system 300 in accordance with an illustrative embodiment. In one embodiment, the augmented reality system 300 may include wireless earpieces 302 (described collectively rather than individually) and augmented reality glasses 304. The augmented reality glasses 304 may include or be connected to an augmented reality computing or communications system, such as a gaming device, server, personal computing device, or so forth. In one embodiment, the wireless earpieces 302 may enhance communications and functionality of the augmented reality system 300. For example, the wireless earpieces 302 may provide high quality audio that compliments the augmented environments provided by the augmented reality glasses 304. In addition, the wireless earpieces 302 may include sensors 317 that detect the location, position, orientation, movement, and acceleration of the user for providing feedback to the augmented reality glasses 304. The sensors 317 may augment the measurements taken by the augmented reality glasses 304.

In one embodiment, the augmented reality system 300 may be utilized as part of a conferencing system, such as the conferencing system 200 of FIG. 2. The augmented reality system 300 may represent any number of systems that may be utilized by individual users, or groups of users. As previously described, the augmented reality system 300 may determine the relative locations and positions of the users to display the user's to each other as if approximately located even though the users are remotely located utilizing augmented reality content. The augmented reality content including audio, video, and text may be displayed utilizing the relevant position, orientation, and other information created for the augmented/virtual environment.

As shown, the wireless earpieces 302 may be physically or wirelessly linked to the augmented reality glasses 304 (e.g., Bluetooth, Wi-Fi, wired connectors, and magnetic couplers, etc.). User input and commands may be received from either the wireless earpieces 302 or the augmented reality glasses 304 for implementation on either of the devices of the augmented reality system 300 (or other externally connected devices). As previously noted, the wireless earpieces 302 may be referred to or described herein as a pair (wireless earpieces) or singularly (wireless earpiece). The description may also refer to components and functionality of each of the wireless earpieces 302 collectively or individually.

The wireless earpieces 302 play the audio corresponding to the augmented reality content displayed by the augmented reality glasses 304. In one embodiment, the wireless earpieces 302 may play the sounds and audio received from the augmented reality glasses 304 based on the sensed location, position, orientation, speed, and acceleration of the user as measured by the sensors 317. For example, if the user's head is facing another user that is speaking the augmented reality content is presented as if the user were facing the user in person (rather than virtually). In another example, if the user is facing forward and a second user is to her left, the user will experience the augmented reality content with audio primarily played through the left wireless earpiece with a view of the user that may be visible at the extreme left periphery of the augmented reality glasses 304. The augmented reality content may vary as the user moves or turns or tils her head in any number of directions and from various positions (e.g., sitting, standing, etc.). In another example, the audio and sounds may be played as if the user's head was turned a particular direction. For example, the sounds and audio may be more prominent in the right ear rather than the left ear based on the position and orientation of the user detected by the wireless earpieces 302. In addition, the wireless earpieces 302 may provide additional biometric and user data that may be further utilized by the augmented reality glasses 304 or connected computing, entertainment, or communications.

In some embodiments, the augmented reality system 300 or the augmented reality glasses 304 may act as a logging tool for receiving information, data, or measurements made by the wireless earpieces 302. For example, the augmented reality glasses 304 may be worn by the user to download data from the wireless earpieces in real-time. For example, the augmented reality system 300 may record a conference call or other communication for any number of subsequent viewing parties. In addition, the augmented reality glasses 304 may be utilized to store, display, and synchronize data to the wireless earpieces 302. For example, the augmented reality glasses 304 may display pulse, oxygenation, distance, calories burned, and so forth as measured by the wireless earpieces 302. The wireless earpieces 302 and the augmented reality glasses 304 may have any number of electrical configurations, shapes, and colors and may include various circuitry, connections, and other components.

In one embodiment, the wireless earpieces 302 may include a battery 308, a logic engine 310, a memory 312, user interface 314, physical interface 315, a transceiver 316, and sensors 317. Similar components within the augmented reality glasses 304 may be similarly structured to provide analogous functionality, features, and processes. Likewise, the augmented reality glasses 304 may have a battery 318, a memory 320, a user interface 322, sensors 324, a logic engine 326, a display 328, and a transceiver 330. The battery 208 is a power storage device configured to power the wireless earpieces 302. Likewise, the battery 318 is a power storage device configured to power the augmented reality glasses 304. The battery 318 may represent a converter, inverter, or interface for receiving power and/or communications from an augmented reality processing system (not shown). In other embodiments, the batteries 208 and 218 may represent a fuel cell, thermal electric generator, piezo electric charger, solar charger, ultra-capacitor, or other existing or developing power storage technologies.

The logic engine 310 is the logic that controls the operation and functionality of the wireless earpieces 302. The logic engine 310 may include circuitry, chips, and other digital logic. The logic engine 310 may also include programs, scripts, and instructions that may be implemented to operate the logic engine 310. The logic engine 310 may represent hardware, software, firmware, or any combination thereof. In one embodiment, the logic engine 310 may include one or more processors. The logic engine 310 may also represent an application specific integrated circuit (ASIC) or field programmable gate array (FPGA). The logic engine 310 may utilize information from the sensors 212 to determine the biometric information, data, and readings of the user. The logic engine 310 may utilize this information and other criteria to inform the user of the biometrics (e.g., audibly, through an application of a connected device, tactilely, etc.). The logic engine 310 may also determine the location, orientation, position, speed, and acceleration of the user utilizing the sensors 217. For example, the sensors 217 may include accelerometers, gyroscopes, optical sensors, or miniaturized radar that may be utilized to determine associated user information. The logic engine 310 may also control how audio information is both sent and received from the transceiver 316 of the wireless earpieces 302.

The logic engine 310 may also detect the position and orientation of other users based on detected measurements and input (e.g., audio readings, head orientation, received signals, etc.). Information, such as signal strength, position, orientation, time delay, user height, furniture location, and other information may also be utilized. The logic engine 310 may also process user input to determine commands implemented by the wireless earpieces 302 or sent to the wireless earpieces 204 through the transceiver 316. The user input may be determined by the sensors 217 to determine specific actions to be taken. In one embodiment, the logic engine 310 may implement a macro allowing the user to associate user input as sensed by the sensors 217 with commands. The macros may also be utilized to implement specific conferencing scenarios. For example, the user may sit in a designated position during work conferences and that information may be saved as user preferences or settings for implementing subsequent augmented conference calls. For example, the macro may remember the location, orientation, furniture, volume settings, add-on data, and other information communicated through the wireless earpieces 302 (and/or alternatively the augmented reality glasses 304).

In one embodiment, a processor included in the logic engine 310 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications components of the augmented reality glasses or a smart case.

The memory 312 is a hardware component, device, or recording media configured to store data for subsequent retrieval or access at a later time. The memory 312 may be or include static and/or dynamic memory. The memory 312 may include one or more of a hard disk, random access memory, cache, removable media drive, mass storage, or configuration suitable as storage for data, instructions, and information. In one embodiment, the memory 312 and the logic engine 310 may be integrated. The memory may use any type of volatile or non-volatile storage techniques and mediums. The memory 312 may store information related to the status of a user, wireless earpieces 302, augmented reality glasses 304, and other peripherals, such as a wireless device, smart case for the wireless earpieces 302, smart watch, and so forth. In one embodiment, the memory 312 may display instructions or programs for controlling the user interface 714 including one or more LEDs or other light emitting components, speakers, tactile generators (e.g., vibrator), and so forth. The memory 312 may also store the user input information associated with each command. The memory 312 may also store instructions including settings, user profiles, or user preferences for implementing telecommunications conferencing (e.g., video, audio, augmented reality, or a combination thereof).

The transceiver 316 is a component comprising both a transmitter and receiver which may be combined and share common circuitry on a single housing. The transceiver 316 may communicate utilizing Bluetooth, Wi-Fi, ZigBee, Ant+, near field communications, rear-field magnetic induction (NFMI), wireless USB, infrared, mobile body area networks, ultra-wideband communications, cellular (e.g., 3G, 4G, 5G, PCS, GSM, etc.) or other suitable radio frequency standards, networks, protocols, or communications. The transceiver 316 may also be a dual or hybrid transceiver that supports a number of different communications. For example, the transceiver 316 may communicate with the augmented reality glasses 304 or other systems utilizing wired interfaces (e.g., wires, traces, etc.), NFC, or Bluetooth communications.

The components of the wireless earpieces 302 (or the augmented reality system 300) may be electrically connected utilizing any number of wires, contact points, leads, busses, wireless interfaces, or so forth. In addition, the wireless earpieces 302 may include any number of computing and communications components, devices or elements which may include busses, motherboards, circuits, chips, sensors, ports, interfaces, cards, converters, adapters, connections, transceivers, displays, antennas, and other similar components. The physical interface 215 is hardware interface of the wireless earpieces 302 for connecting and communicating with the augmented reality glasses 304 or other electrical components. In one embodiment, the physical interface 215 may be utilized to charge the battery 208.

The physical interface 215 may include any number of pins, arms, or connectors for electrically interfacing with the contacts or other interface components of external devices or other charging or synchronization devices. For example, the physical interface 215 may be a micro USB port. In one embodiment, the physical interface 215 is a magnetic interface that automatically couples to contacts or an interface of the augmented reality glasses 304. In another embodiment, the physical interface 215 may include a wireless inductor for charging the wireless earpieces 302 without a physical connection to a charging device.

The user interface 214 is a hardware interface for receiving commands, instructions, or input through the touch (haptics) of the user, voice commands, or predefined motions. The user interface 214 may be utilized to control the other functions of the wireless earpieces 302. Although not shown, the one or more speakers of the user interface 214 may include a number of speaker components (e.g., signal generators, amplifiers, drivers, and other circuitry) configured to generate sounds waves at distinct frequency ranges (e.g., bass, woofer, tweeter, midrange, etc.) or to vibrate at specified frequencies to be perceived by the user as sound waves.

The speakers may also generate sound waves to provide three-dimensional stereo sound to the user. All or portions of the speakers may be activated or directed within the wireless earpieces 302 to generate various effects. The speakers may play audio content and provide other tactile feedback as if remote users are present even though they are physically located elsewhere. For example, the speakers may simulate a conference of two or more individuals even though at least two of the individuals are remotely located from one another. The speakers may quickly respond to content sent from the augmented reality glasses 304 or other portions of the augmented reality system 300 to add to the realistic effects and processing experienced by the user.

The user interface 214 may include an LED array, one or more touch sensitive buttons or screens, portions or sensors, a miniature screen or display, or other input/output components. The user interface 214 may be controlled by the user or based on commands received from the augmented reality glasses 304 or a linked wireless device. The user interface 214 may also include traditional software interfaces, such as a graphical user interface or applications that may be executed by the logic engine 310 for communication by the user interface 214. For example, the speakers may simulate users, devices, or sounds spatially positioned relative to the user wearing the wireless earpieces 302. As a result, a person or animal that appears to be forward and to the left of the user will also sound like they are so positioned based on sounds received and played by the wireless earpieces 302 relative to the communicated media content.

In one embodiment, the user may provide feedback by tapping the user interface 214 once, twice, three times, or any number of times. Similarly, a swiping motion may be utilized across or in front of the user interface 214 (e.g., the exterior surface of the wireless earpieces 302, proximate the exterior surface for optical sensors) etc.) to implement a predefined action. Swiping motions in any number of directions may be associated with specific activities, such as play music, pause, fast forward, rewind, activate a digital assistant (e.g., Siri, Cortana, smart assistant, etc.). The swiping motions may also be utilized to control actions and functionality of the augmented reality glasses 304 or other external devices (e.g., smart television, camera array, smart watch, etc.). The user may also provide user input by moving her head in a particular direction or motion or based on the user's position or location. For example, the user may utilize voice commands, head gestures, or touch commands to change the content displayed by the augmented reality glasses 304. The user may also utilize voice commands or gestures to answer an incoming conference call or to activate one or more cameras in communication with the augmented reality system 300 to enable augmented reality enhanced communications. The voice and audio input from the user and received from the augmented reality system 300 may be enhanced to accurately determine position, location, orientation, motion and acceleration of the user/user's head within a three-dimensional space. As a result, audio or sound effects, such as loudness, masking, pitch (including changes, such as the Doppler effect), timbre, localization, and other user affects heard and perceived by the user may be varied.

The sensors 217 may include pulse oximeters, accelerometers, gyroscopes, magnetometers, inertial sensors, photo detectors, microphones (e.g., ear-bone or bone conduction microphones, exterior microphones, etc.) miniature cameras, and other similar instruments for detecting location, orientation, motion, and so forth. The sensors 217 may also be utilized to gather optical images, data, and measurements and determine an acoustic noise level, electronic noise in the environment, ambient conditions, and so forth. The sensors 217 may provide measurements or data that may be utilized to filter or select images for display by the augmented reality glasses 304. For example, motion or sound detected on the left side of the user may be utilized to command the smart glasses to display camera images from the left side of the user. Motion or sound may be utilized, however, any number of triggers may be utilized to send commands to the augmented reality glasses 304. The sensors 217 may determine the location of the user which may include position and orientation of the user and/or user's head. The information from the sensors 217 may be utilized to generate the augmented reality data utilized in the conference communications.

The microphones of the sensors 217 may immediately receive and process audio signals and sounds from the user thereby minimizing latency and delay. As a result, the augmented reality system 300 may perform effectively for real-time scenarios, simulations, games, communications, or so forth. The microphones may sense verbal feedback from the user as well as audio input associated with the user and environment (e.g., foot falls, breaths, grunts, wind, etc.) to provide relevant information to the augmented reality system 300. The microphones may include external microphones positioned on the outside surface(s) of the wireless earpieces 302 (e.g., air microphones) as well as internal microphones (e.g., bone, ear-bone microphones, etc.). Audio input may also be sensed by the microphones to determine the general location or direction of the user wearing the wireless earpieces or other users communicating with the user.

The augmented reality glasses 304 may include components similar in structure and functionality to those shown for the wireless earpieces 302 including a battery 318, a memory 320, a user interface 322, sensors 324, a logic engine 326, a display 328, a transceiver 330, and a physical interface 332. The augmented reality glasses 304 may include the logic engine 326 for executing and implementing the processes and functions as are herein described. The battery 318 of the augmented reality glasses 304 may be integrated into the frames of the augmented reality glasses 304 and may have extra capacity which may be utilized to charge the wireless earpieces 302. For example, the wireless earpieces 302 may be magnetically coupled or connected to the augmented reality glasses 304 so that the battery 318 may be charged. All or a portion of the logic engine 326, sensors, user interface 322, sensors 324, display, and transceiver 330 may be integrated in the frame and/or lenses of the augmented reality glasses 304.

The user interface 322 of the augmented reality glasses 304 may include a touch interface or display for indicating the status of the augmented reality glasses 304. For example, an external LED light may indicate the battery status of the augmented reality glasses 304 as well as the connected wireless earpieces 302, connection status (e.g., linked to the wireless earpieces 302, wireless device, etc.), download/synchronization status (e.g., synchronizing, complete, last synchronization, etc.), or other similar information. Commands for either the wireless earpieces 302 or the augmented reality glasses 304 may be received through the user interfaces 314, 322 of either device.

The display 328 may be integrated into the lenses of the augmented reality glasses 304 or may represent one or more projectors that may project content directly or reflectively to the eyes of the user. For example, the display 328 may represent a transparent organic light emitting diode lens that is see through and may be utilized to display content. In another example, projectors of the display 328 may utilize any number of wavelengths or light sources to display data, images, or other content to the user. The augmented reality glasses 304 may generate or display augmented reality or virtual reality content. The augmented reality glasses 304 may take any number of forms including regular glasses, disposable headsets, and so forth. The augmented reality glasses 304 may be very small and unobtrusive. In one embodiment, the augmented reality glasses 304 may be integrated in smart contact lenses that communicate with the wireless earpieces 302 as described herein. In one embodiment, the augmented reality glasses 304 may augment the view of the user with one or more users or environments to provide effective communications or conferencing.

An LED array of the user interface 322 may also be utilized for display actions. For example, an LED may be activated in response to a conference call being initiated. In another embodiment, device status indications (e.g., battery status, call status, application status, etc.) may emanate from the LED array of the wireless earpieces 302 themselves, triggered for display by the user interface 322 of the augmented reality glasses 304.

The physical interface 332 may be utilized to connect the wireless earpieces 302 and the augmented reality glasses 304. For example, the physical interface 332 may include a micro-USB, mini-USB, or other connectors, ports, and interfaces. The physical interface 332 may be utilized to physically communicate power, data, or other signals to and from the augmented reality glasses 304. For example, the battery 318 may itself be charged through the physical interface 332 of the augmented reality glasses 304. The physical interface 332 may be integrated with the user interface 322 or may be a separate interface. For example, the physical interface 332 may be utilized to connect the augmented reality glasses 304 to a power supply or other electronic devices. The user interface 322 may be utilized for charging as well as communications with externally connected devices. For example, the user interface 322 may represent a mini-USB, micro-USB or other similar miniature standard connector. The physical interface 332 may be connected to the physical interface 315 of the wireless earpieces 302 to power the wireless earpieces 302 as well as communicate augmented reality or audio content. In another embodiment, a wireless inductive charging system may be utilized to charge or replenish power to the wireless earpieces 302 or the augmented reality glasses 304.

In another embodiment, the augmented reality glasses 304 may also include sensors for detecting the location, orientation, and proximity of the wireless earpieces 302. For example, the augmented reality glasses 304 may include optical sensors or cameras for capturing images and other content around the periphery of the user (e.g., front, sides, behind, etc.). For example, the supplemental cameras may capture images of surrounding users participating in a conference call that may be utilized to generate augmented reality content that may be communicated to other pairs of augmented reality glasses. The augmented reality glasses 304 may detect any number of wavelengths and spectra to provide distinct images, enhancement, data, and content to the user. The augmented reality glasses 304 may also include an LED array, galvanic linkage or other touch sensors, battery, solar charger, actuators or vibrators, one or more touch screens or displays, an NFC chip, or other components. The sensors 324 may include integrated sensors that are part of the augmented reality glasses 304 as well as external sensors that communicate with the augmented reality glasses 304. For example, the sensors 324 may also measure the position, location, orientation, motion, and acceleration of other portions of the user's body including arms, legs, torso, and so forth. The sensors 324 may also be utilized to generate augmented reality content for the user based on the location, position, and orientation of the user's head (and corresponding virtual field of view).

As originally packaged, the wireless earpieces 302 and the augmented reality glasses 304 may include peripheral devices such as charging cords, power adapters, inductive charging adapters, solar cells, batteries, lanyards, additional light arrays, speakers, smart case covers, transceivers (e.g., Wi-Fi, cellular, etc.), or so forth.

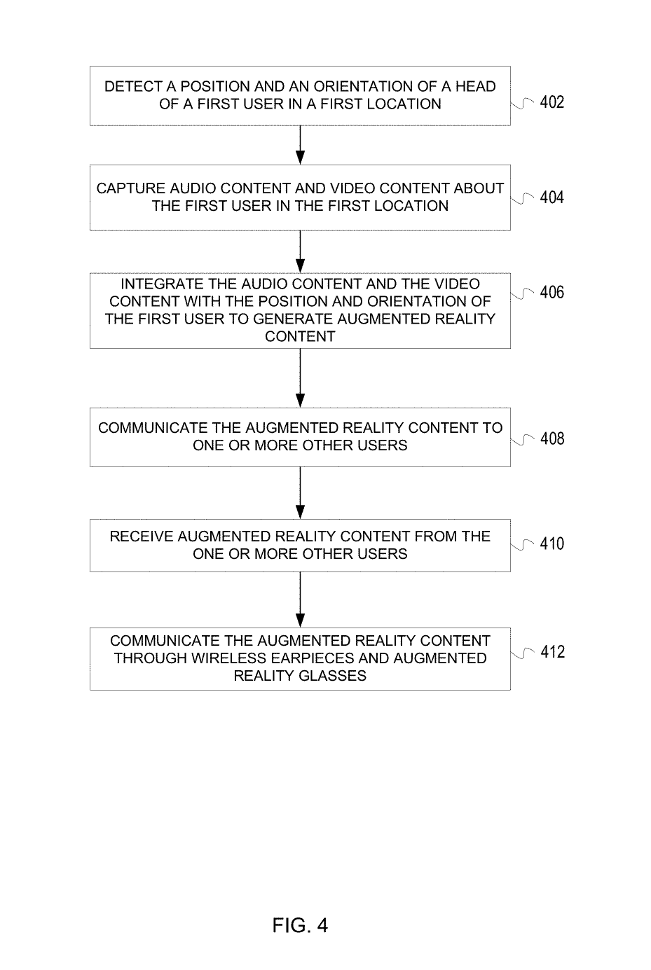

FIG. 4 is a flowchart of a process for communicating utilizing an augmented reality system in accordance with an illustrative embodiment. In one embodiment, the process of FIG. 3 may be implemented by one or more augmented reality systems. The augmented reality systems may include one or more wireless earpieces and augmented reality glasses, such as the wireless earpieces 102 and virtual reality glasses 124 (or virtual reality headset 110) of FIG. 1. The method of FIG. 4 may be performed to perform augmented reality communications or conferences communicate information the augmented reality systems.

The wireless earpieces may synchronize playback of three-dimensional sound and audio. The wireless earpieces and augmented reality glasses may also synchronize the location, orientation, and position of the user to display accurate augmented reality content and information, such as location, position, angle, and motion of the user's head (as well as body), and so forth, to secondary systems. In addition to the augmented reality glasses, the wireless earpieces may communicate with one or more cameras and microphones that may capture video, audio, and images from a number of locations (e.g., a first location, a second location, a third location, etc.) to generate augmented reality content that may be utilized to perform a virtual conference with a number of users in remote locations/environments. The wireless earpieces may be physically or virtually connected to the virtual reality headset and/or a virtual reality communications, processing or computing system (e.g., gaming system, server, personal computer, cell phone, etc.). For example, the wireless earpieces and the augmented reality glasses may be connected by a wire interface that both powers the wireless earpieces and communicates and receives audio content from the wireless earpieces.

In one embodiment, the process may begin by detecting a position and an orientation of a head of a first user in a first location (step 402). The position and the orientation of the first user's head may be determined utilizing one or more accelerometers, gyroscopes, proximity sensors, optical sensors, or other sensors of the wireless earpieces or the virtual reality glasses. One or more cameras of the augmented reality system may also determine the location including the position and orientation of the user. The information and data regarding the user may be utilized to generate augmented reality content for additional users with which the user is communicating. The position and orientation may include global positioning information, spatial positioning within a room or other environment, x, y, and z orientation of the user's head utilizing any number of planes or axis, distance between objects (e.g., user's head and the floor/wall, etc.).

Next, the augmented reality system captures audio and video content about the first user in the first location (step 404). The audio content may be captured by the wireless earpieces worn by the first user. For example, the audio content may also be received from the user by one or more microphones of the wireless earpieces including ear-bone and external microphones to detect the voice, sounds, or other audio input from the user. The microphones may also sense content associated with the user's environment, such as other users proximate the user, organic, mechanical, or electric sounds, or so forth. The video content may be captured by cameras integrated with the augmented reality system. Video may also be captured by one or more cameras integrated with the augmented reality glasses. In one embodiment, the audio and video content may be integrated material or content from a conference communication, simulation, game, broadcast, or other media.

Next, the augmented reality system integrates the audio and video content with the position and orientation of the first user to generate augmented reality content (step 406). In one embodiment, the position, orientation, audio, and visual content received from the first user (e.g. verbal commands, communications, indicators, stimuli, etc.) may be utilized to generate augmented reality content that may be communicated to additional users (e.g., a second user). For example, the various types of content may be aggregated to perform a virtual conference communication utilizing augmented reality. The content may be aggregated by the wireless earpieces, augmented reality glasses, wireless/computing device, or an augmented reality processing system. The augmented reality system may utilize user preferences or settings to generate the augmented reality content. The user preferences and settings may include light filtering, background images, voice detection, amplitude, and so forth. The audio, video, and augmented reality content may also be enhanced utilizing filtering, amplification, signal processing, and other processes to remove unwanted noise, jitter, latency, or so forth. In one embodiment, the augmented reality content includes data, images, charts, or other information that is digitally added as part of the augmented reality content. During step 406, the augmented reality system may also integrate streams from a number of other users together. The various streams may be stitched together to create a single cohesive communication, such as an augmented reality conference call including video, audio, text, data, and/or other information. The augmented reality content may be communicated in any number of formats (e.g., mp4, mp3, Flash video (FLV)). Any number of protocols or standards may be utilized for compressing the augmented reality content, encoding the content, encrypting the content, and otherwise preparing and communicating the augmented reality content.

Next, the augmented reality system communicates the augmented reality content to one or more users (step 408). The augmented reality content may be communicated directly or indirectly through wired or wireless signals, connections, and networks. Step 408 may represent content that is streamed in real-time rather than discrete communications. However, the augmented reality content may include discrete content, such as information, data, text, alerts, images, or so forth.

Next, the augmented reality system receives augmented reality content from the one or more other users (step 410). The augmented reality system may receive the content directly or indirectly through any number of devices, systems, equipment, or so forth. For example, the augmented reality system may communicate with remote augmented reality systems to implement a remote conference where the augmented reality content integrates the view of each of the applicable users. The augmented reality content received from the one or more other users may be integrated with the augmented reality content generated from the first user to provide a virtual/augmented conference with two or more users.

Next, the augmented reality system communicates the augmented reality content through at least wireless earpieces and augmented reality glasses (step 412). During step 412, the audio and tactile content may be played by the wireless earpieces. The visual content (e.g., video, images, graphics) and tactile content may be visually displayed by the augmented reality glasses. In other embodiments, the wireless earpieces and the augmented reality glasses may be integrated or connected. The augmented reality glasses may include display components or projection components for displaying the augmented reality content directly or directly to the eyes of the user.

The augmented reality system may choose one of the locations of the user as the master, home, or default location or environment. The augmented reality content may be enhanced by including video from users not in the default location to provide a virtual conference for all participants. The movements and head motions of the various users may be displayed to simulate eye contact and attention to individual speakers or presentations being given. For example, a presentation, such as a power point or multi-media presentation, may be integrated with the augmented reality content. As a result, users, objects, media, and other captured content may be shared between the users in a spatially accurate way. In one embodiment, the user's may be virtually positioned within the default conference environment. The augmented reality system may provide instructions to best integrate the user, such as “please turn slightly to the left.”

The augmented reality content may be delivered without significant delay or latency. As a result, all video, pictures, or other visual content may be synchronized with the audio content delivered by the wireless earpieces to prevent unwanted dizziness, disorientation, or motion sickness due to differing inputs. The immediate delivery of the audio content may ensure that real-time or time sensitive applications, such as communications, gaming, simulations, or so forth are implemented without delay. As previously noted, the audio content may be sent and received from the virtual reality headset/system utilizing any number of connections. In one embodiment, the virtual reality headset is magnetically coupled to the wireless earpieces allowing for inductive power transfer and communication between the connectors and the wireless earpieces. In yet other embodiments, short range wireless signals, such as Bluetooth, ANT+, or other radiofrequency protocols, standards, or connections may be utilized.

The playback and communication of audio content may be coordinated based on user actions, conditions, position, location, or so forth. For example, specific three-dimensional noises may be played in each of the wireless earpieces corresponding to the left and right ears of the user to make the environment seem more realistic. Likewise, the volume and other audio effects may be varied to match the orientation of the user's head (or avatar) within a virtual environment. The augmented reality content may include flags, timestamps, or other information for synchronizing playback. The synchronization of the audio and visual content may ensure that the user does not become disoriented, motion sick, or otherwise adversely affected. The audio content may be delivered, played, or otherwise communicated based on synchronization information determined between the augmented reality glasses and the wireless earpieces. For example, the left and right wireless earpieces may play distinct content based on the virtual reality environment with which the user is interacting. Distinct sounds, volumes, and audio effects may be utilized by each of the wireless earpieces. As a result, the user is able to experience a unique augmented reality environment with corresponding sounds without significant increases in weight or other forces imposed upon the user by much larger sound systems.

Although, not specifically described, the process of FIG. 3 may begin with the wireless earpieces being linked with an augmented reality headset. In one embodiment, the user may magnetically couple the wireless earpieces with the augmented reality glasses. For example, each side of the virtual reality headset may include a connector corresponding to the left and right wireless earpieces. The wireless earpieces may include magnetic contacts that couple the two devices to communicate data as well as provide a power connection for powering the wireless earpieces utilizing power provided by the virtual reality headset (e.g., battery, power adapter, USB connection, etc.). As a result, the power capacity of the wireless earpieces may be increased significantly. In another embodiment, either of the wireless earpieces or the augmented reality glasses may include connectors and ports for physically connecting to one another. The two devices may also communicate utilizing an inductive connection between the wireless earpieces and the augmented reality glasses. In another embodiment, the wireless earpieces and the connectors of the augmented reality glasses may utilize short range communications, such as Bluetooth, ANT+, or other radiofrequency communications to communicate. The wireless earpieces may be integrated whether connected to connectors, extensions, arms, the frame, or other portions of the augmented reality glasses.

The wireless earpieces may also synchronize playback or communication of the audio content with visual content of the augmented reality system. As previously noted, the wireless earpieces may utilize any number of sensors to determine the location, velocity (e.g. linear, angular, etc.), position of the user (and the user's head), orientation, acceleration, biometric condition (e.g., heart rate, blood oxygenation, temperature, etc.), and other information to adjust the exact timing, volume, tuning, balance, fade, and other audio effects communicated to the user by the speakers of the wireless earpieces. The wireless earpieces may also send or receive commands for synchronizing and managing the audio content played or communicated by the wireless earpieces with associated visual content.

The illustrative embodiments provide a system, method, and wireless earpiece(s) for communicating utilizing an augmented reality system. In one embodiment, the augmented reality content may be utilized for virtual conferences that include multiple participants remotely located. Audio and video inputs may be enhanced with augmented reality content and sent and received based on user information that may include the location, position, orientation, motion, and acceleration of the user. The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

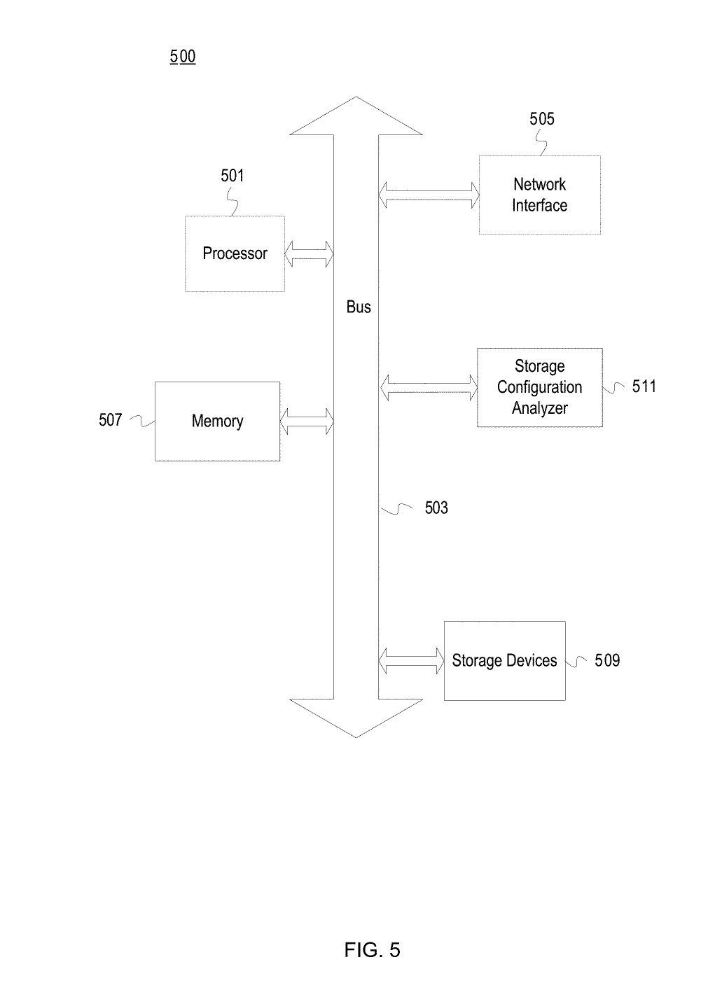

FIG. 5 depicts a computing system 500 in accordance with an illustrative embodiment. For example, the computing system 500 may represent an electronic computing or communications device, such as a virtual reality system. The virtual reality system may communicate with wireless earpieces, a virtual reality headset, sensors, or other electronics, devices, systems, equipment, or components. The computing device 500 may be utilized to receive user settings, instructions, or feedback for controlling the power management features of the wireless earpieces together and separately. The computing system 500 includes a processor unit 501 (possibly including multiple processors, multiple cores, multiple nodes, and/or implementing multi-threading, etc.). The computing system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc.), and a storage device(s) 509 (e.g., optical storage, magnetic storage, etc.). The system memory 507 embodies functionality to implement embodiments described above. The system memory 507 may include one or more functionalities that recognize user information for communicating audio content to the wireless earpieces, virtual reality headset, or so forth. The system memory 507 may also process audio input received from wireless earpieces, virtual reality headsets, or other devices. Code may be implemented in any of the other devices of the computing system 500. Any one of these functionalities may be partially (or entirely) implemented in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 509, and the network interface 505 are coupled to the bus 503. Although illustrated as being coupled to the bus 503, the memory 507 may be coupled to the processor unit 501.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for augmented reality communications, comprising:
determining locations of two or more users, wherein at least a first user is in a first location and a second user is in a second location remote from the first location;
capture voice content from the first user and the second user through at least wireless earpieces worn by both the first user and the second user; and
sending augmented reality content including at least the voice content between at least the first user and the second user.

2. The method of claim 1, wherein the wireless earpieces detect the locations of the first user and the second user including a position and an orientation of the first user and the second user.

3. The method of claim 2, wherein the wireless earpieces and augmented reality glasses worn by the first user and the second user comprise augmented reality systems utilized to communicate the augmented reality content between the first user and the second user.

4. The method of claim 3, wherein the augmented reality content includes a visual representation of the second user for the first user and a visual representation of the first user for the second user.

5. The method of claim 1, wherein the determining further comprises:
capturing the locations utilizing cameras in the first location and the second location.

6. The method of claim 1, wherein the wireless earpieces include pairs of wireless earpieces worn by the first user and the second user, and wherein at least accelerometers and gyroscopes of the wireless earpieces determine the location of the first user in the first environment and the second user in the second environment.

7. The method of claim 1, wherein the augmented reality content includes a virtual environment comprised of at least portions of the first environment and the first user and the second environment and the second user.

8. The method of claim 1, further comprising:
linking a first pair of the wireless earpieces utilized by the first user with augmented reality glasses worn by the first user; and
synchronizing playback of audio content through the first pair of wireless earpieces with visual content displayed by the augmented reality glasses, wherein the audio content and the visual content are part of the augmented reality content.

9. The method of claim 1, wherein the augmented reality content comprises a conference communication between a plurality of users including the first user.

10. The method of claim 1, wherein the audio content from the wireless earpieces and video content from one or more cameras is integrated to generate the augmented reality content.

11. An augmented reality system, comprising:
augmented reality glasses for displaying augmented reality content to a first user including one or more additional users as if located proximate the user;
wireless earpieces including sensors that detect a position and an orientation of a head of the first user, wherein the wireless earpieces play audio content from the augmented reality content to the first user as if the one or more additional users are proximate the user, and wherein the wireless earpieces receive audio content from the first user for communication to the one or more additional users as part of the augmented reality content.

12. The augmented reality system of claim 11, further comprising:
one or more cameras that capture video content associated with the first user for integration as part of the augmented reality content.

13. The augmented reality system of claim 12, wherein speakers of the wireless earpieces deliver the audio content in response to the orientation and position of the one or more additional users.

14. The augmented reality system of claim 13, wherein the augmented reality content includes a visual representation of the first user and the one or more additional users in a single environment.

15. The augmented reality system of claim 14, wherein the audio content is received through two or more microphones including at least an ear-bone microphone and an external microphone.
